(19) United States
(12) Patent Application Publication
(10) Pub. No.: US 2018/0355828 A1
(43) Pub. Date: Dec. 13, 2018

(54) FUEL HEATING DEVICE HAVING A HEATING DEVICE

(71) Applicants: Mahle Metal Leve S/A, Jundiai (BR); Mahle International GmbH, Stuttgart (DE)

(72) Inventors: Tadeu Miguel Malago Amaral, Sao Paulo (BR); Edson Valdomiro De Azevedo Junior, Sao Paulo (BR)

(21) Appl. No.: 15/779,845

(22) PCT Filed: Nov. 29, 2016
(86) PCT No.: PCT/EP2016/079166

§ 371 Date: May 29, 2018

(30) Foreign Application Priority Data
Nov. 30, 2015 (BR) 10 2015 030 039 5

(51) Int. Cl. F02M 53/06; F02M 31/125; F02M 53/02

(52) U.S. Cl. CPC F02M 53/06; F02M 31/125; H05B 1/0236; F02M 2200/95; F02M 2200/60; F02M 53/02

(57) ABSTRACT

A fuel heating device may include a fuel inlet, at least one fuel outlet, at least one inner chamber, and at least one heat exchanger. The at least one heat exchanger may include at least one first heating element and at least one second heating element arranged within an opening arranged within an interior of the at least one heat exchanger. The heat exchanger may include a first electrical conductor arranged in the interior and electrically contacting the at least one first heating element. The heat exchanger may further include a second electrical conductor electrically contacting an outer surface of the at least one heat exchanger. The at least one heat exchanger may include a ribbed portion including a plurality of ribs. The plurality of ribs may be arranged on the outer surface of the at least one heat exchanger and configured to contact the fuel.

### CROSS-REFERENCE TO RELATED APPLICATIONS

This application claims priority to International Patent Application No. PCT/EP2016/079166, filed on Nov. 29, 2016, and Brazilian Patent Application No. BR 10 2015 030039 5, filed on Nov. 30, 2015, the contents of both of which are hereby incorporated by reference in their entirety.

### TECHNICAL FIELD

The present invention relates to a heating device for a fuel heating device which, for example, can be used for cold starting, a better drivability, reduced greenhouse gas emissions and other applications in motor vehicles. The invention relates, furthermore, to a fuel injection device equipped with at least one such heating device.

### BACKGROUND

Cold start systems which are equipped with at least one such fuel heating device are currently used in the automobile industry, in particular in vehicles which use fuels having low volatility, such as ethanol, methanol or a duel fuel technology. Such fuels ignite comparatively poorly at low environmental temperatures, which in particular makes the starting of the respective internal combustion engine difficult. Corresponding problems can also occur in particular in bio fuels and in fuel mixtures of fossil fuel and bio fuel. As is known among specialists, the appropriate combustion of the alcohol depends on the temperature. Earlier, it was entirely usual that drivers had difficulties on colder days in starting their vehicles operated with alcohol. The generally known technology of the “petrol tank”, the basis of which is the additional petrol injection, in order to increase the volatility of the fuel mixture, was a giant breakthrough and is represented today in most flexible fuel vehicles in Brazil, which accelerates the cold starting on cooler days, although, however, it still has various disadvantages, such as for example the high greenhouse gas emission, high safety risks and leaks, and the disadvantage that the user must not forget to refill the “petrol tank” on cold days, in order to enable the cold starting of the vehicle.

Aware of this reality, companies and researchers therefore developed electrical heating solutions, so that the fuel is heated minimally above its flash point. Thereby, it is to be achieved that the engine is also started on cold days and no additional petrol injection or generally known “petrol tank for cold starting” are necessary. An example of the heating technique which is used is the heating element known as a “glow plug”. The type of heating device originates from the diesel vehicle applications, has the form of a metal rod and is incorporated into the fuel line and heats the fuel which runs there, before the latter is injected into the engine or into the engine inlet.

Despite the development with respect to the “petrol tank”, this heating technique uses a high temperature heating device for a rapid heating and therefore increases the risks of the fuel boiling procedure (in this case vapour is injected instead of liquid fuel, which causes engine damage), overheating, an internal pressure increase in the components, leaks and, in extreme cases, even burning or the melting of plastic parts. Other fuel heating techniques for cold starting were created, although in different geometric constructions and positions from those of the “glow plug”, wherein for example some fuel heating techniques were incorporated into the fuel nozzle. Hitherto, all have a low heat exchange surface with the fuel and operate at high temperatures, although, however, overheating- and safety risks of the heating device of the “glow plug” type persist.

In order to circumvent the overheating risk of the fuel, fuel heating devices operate in connection with a heating regulation unit, i.e. with an electronic “hardware” which monitors the heating of each heating device and switches the latter off in the case of an overheating, wherein this operates in real time within a closed control circuit. Owing to the precise electronic “monitoring hardware”, this technology is expensive, complex to implement and requires an additional expenditure in terms of time, in order to calibrate the vehicle and to adapt and program the preheating times, and in addition it should be taken into consideration that, when an electronic component of the system is damaged or its connection fails after use for years, this can lead to a catastrophe owing to the high temperatures which the heating devices can reach in contact with fuel.

In order to solve the disadvantages and inconveniences of this cold starting system, the applicant developed a new system in which the usual heating devices were replaced by a heating element of the “PTC thermistor” type (thermistor with positive temperature coefficient) together with a highly efficient heat exchanger. Thus, the fuel, owing to its positioning between the inlet and outlet of the heating device, enters into contact with the heat exchanger, which feeds the received heat from the interior by means of the “thermistor”. Through this system, the fuel is heated quickly, wherein the latter has recourse to the PTC thermistor with a low surface temperature and controls itself through the doping of semiconductors, wherein the system prevents the fuel from exceeding a particular temperature which is selected or respectively established in the doping and in the manufacturing process of the respective PTC element, and eliminates the inconveniences which previously occurred. The temperature to which such a PTC element is designed and at which the PTC element regulates in a limiting manner so that it reaches this temperature as a maximum, can also be designated as limit regulation temperature. It should be taken into consideration that, although other heating devices of the PTC type exist, only those technologies with PTC without the use of highly efficient heat exchangers require a PTC with a high surface temperature. In addition, the necessity still exists for an electronic “hardware” for the temperature regulation.

Further information concerning the description of the heating system of the PTC type with a highly efficient heat exchanger can be consulted in the documents DE 10 2011 086 201 and DE 10 2012 220 429, the descriptions of which were listed here as reference material. Although this new cold starting system has brought great advantages, some problems still exist, which must be tackled in the prior art.

As can be seen from the above-mentioned documents DE 10 2011 086 201 and DE 10 2012 220 429, the heat exchangers described and illustrated there have a format, the cross-section of which is substantially elongated. This format is work-intensive owing to the working processes generally coming into use. In addition, the elongated format does not enable a uniform heat distribution. The result of this is that such a format is inefficient and that a better solution must be found in the present state of the art.

### SUMMARY

It is therefore the aim of the invention to provide a fuel heating device which enables a simpler heat exchange. The fuel heating device is to generally enable an efficient heating of the respective fuel. Specifically, the fuel heating device is to be able to enable a vaporization of the respective fuel. The latter applies in particular in the case of bio fuels.

A further aim of the present invention is to provide a fuel heating device which enables a uniform heating of the fuel which comes in contact with outer walls of the fuel heating device.

The aims of this invention are achieved through the fuel heating device, which comprises the following: a fuel inlet and at least one fuel outlet, wherein the heating device has at least one inner chamber which is arranged between the fuel inlet and fuel outlet, wherein in the inner chamber at least one heat exchanger is arranged and wherein the heat exchanger has at least one first and one second heating element which are inserted into an opening in the interior of the heat exchanger; the heat exchanger comprises in addition a first electrical conductor in its opening, which conductor is in electrical contact with the first heating element, and a second electrical conductor, which is in electrical contact with the outer surface of the heat exchanger. In addition, the heat exchanger has a round, in particular circular, cross-section.

This fuel heating device has optionally the following additional features and/or characteristics with optional use:
the first electrical conductor is a conductive spring, which comprises a contact portion which produces the contact to the heating elements, and an electrical contact end which produces the contact to an electrical current circuit of a motor vehicle, when the contact portion and the contact end are fully incorporated; and/or
the contact portion of the first electrical conductor has a curved format; and/or
the contact portion consists of two curved, opposite side parts, which stand at a distance from one another; and/or
the first heating element is situated along the one side part of the contact portion of the first electrical conductor and the second heating element is situated along the other side part of the contact portion of the first electrical conductor; and/or
the first and second heating element are fastened on both side parts of the contact portion of the first electrical conductor by means of an electrically non-conducting, therefore electrically insulating holder, e.g. of polymer material, wherein the said holder has a front and a rear support wall, in order to fasten the heating elements, such that they can be removed easily, and central mounts, in order to receive and to position each side part of the contact portion of the first electrical conductor; and/or
the contact portion of the first electrical conductor, the heating elements and the holder form radially a “sandwich” structure; and/or
the fuel heating device comprises in addition at least one heat-conducting foil around the “sandwich” structure; and/or
the heating elements are thermistors, in particular PTC thermistors; and/or
the heat exchanger comprises a grooved or respectively ribbed portion with a plurality of grooves or respectively ribs on its outer surface or respectively outer side; and/or
at least one radial recess can be situated on at least a portion of the outer surface of the heat exchanger, which extends in particular axially; and/or
the holder has a cylindrical shape, wherein its mounts are arranged in the shape of a circular arc and concentrically; and/or
the first and second heating element and at least one possibly present heat-conducting foil have an, in particular circular arc-shaped, curved format; and/or
the fuel heating device comprises at least one deflector arranged in the fuel inlet, the function of which is to divert the incoming flow of fuel into the lower region of the inner chamber of the heating device; and/or
the deflector can engage radially into the above-mentioned recess; and/or
the heat exchanger comprises an upper and continuous sealing portion along the ribbed portion, wherein the function of the said sealing portion is to receive at least one sealing element; and/or
the inner chamber consists of a container and of a fastening- and sealing connecting-piece, wherein the container is configured for receiving the ribbed portion of the heat exchanger and the fastening- and sealing connecting-piece is set to receive the sealing portion of the heat exchanger; and/or
the sealing element is a sealing ring of the “O-ring” type; and/or
a protective cover lies over the sealing portion of the heat exchanger, which protective cover securely holds the first, the second and a possibly provided third electrical conductor; and/or
a plastic cover lies over the protective cover, wherein this plastic cover can be injected onto the protective cover; and/or
the fuel heating device comprises in addition a fastening clamp which is fitted into the through-bores of the fastening connecting-piece and placed around the plastic cover portion which is situated in the interior of the fastening- and sealing connecting-piece. The said clamp comprises in addition free, widened ends, therefore pointing away from one another or respectively outwards; and/or
the fuel inlet of the heating device can be fluidically connected to the fuel outlet of a fuel line and the fuel outlet of the heating device can be directly connected to at least one fuel injector; and/or
the fuel heating device can be fully incorporated into the fuel line; and/or
the first heating element and the second heating element have the same behaviour and the same limit regulation temperature; and/or
the first heating element and the second heating element have different behaviours and limit regulation temperatures; and/or
in the opening a third electrical conductor is present, the second electrical conductor is in electrical contact with the second heating element and has a curved format; and/or
the third electrical conductor is a conductive spring, which comprises a contact portion which produces the contact to the heating elements, and an electrical contact end which produces the contact to an electrical current circuit of a motor vehicle, when the contact portion and the contact end are fully incorporated; and/or
the first heating element is situated along a side part of the contact portion of the first electrical conductor, and the second heating element is situated along a side part of the contact portion of the third electrical conductor; and/or
the first and the second heating element are fastened onto each side part of the contact portion of the first and of the third electrical conductor by means of an electrically insulated holder, e.g. of polymer material, wherein the said holder has a front and rear support wall, in order to position and/or fasten the heating elements, such that they can be easily removed, and, in particular concentric mounts, in order to receive and position the first and third electrical conductors; and/or
the contact portion of the first and the third electrical conductor, the heating elements and the holder form, viewed radially, a “sandwich” structure.

### BRIEF DESCRIPTION OF THE DRAWINGS

These and other aims, the technical and functional improvements and the advantages of the fuel heating system which is the subject of this invention are evident to specialists with the aid of the enclosed diagrammatic figures, which illustrate a preferred, non-restricted, embodiment of this invention.

FIG. 1 shows a view of the fuel heating device of the present invention, which is connected to a fuel line and to fuel injectors, according to a first installation possibility;

FIG. 2 shows a view of the fuel heating device of the present invention, which is connected to a fuel line;

FIG. 3 shows a view of the fuel heating device of the present invention, which is connected to a fuel line and to fuel injectors, according to a second installation possibility;

FIG. 4A shows a detail view and a sectional image of the fuel heating device of the present invention according to a first particular embodiment;

FIG. 4B shows a sectional image of the fuel heating device of the present invention according to a first particular embodiment;

FIG. 5 shows an exploded illustration of the components of the heating device of the present invention according to a first particular embodiment;

FIG. 6 shows a view of the heat exchanger of the fuel heating device according to a first embodiment of the invention;

FIG. 7 shows a view of the electrical conductor of the fuel heating device according to a first embodiment of the present invention;

FIG. 8 shows a view of the holder of the fuel heating device according to a first embodiment of the present invention;

FIG. 9 shows a side view of the portion of the fuel heating device according to a first embodiment of the present invention, wherein the heating device is connected to a fuel line and to a fuel injector in a second installation possibility (as is also shown in FIG. 3);

FIG. 10 shows a side view of the portion of the fuel heating device of the present invention according to a first embodiment, wherein the heating device is connected to a fuel line;

FIG. 11 shows a side view of the portion of the fuel heating device of the present invention according to a first embodiment, wherein the heating device is connected to a fuel line and the internal components of the heating device (with the exception of a deflector) have been removed for better distinguishability;

FIG. 12 shows a sectional image of the fuel heating device according to a first embodiment of the invention, wherein the illustrated heating device comprises a deflector;

FIG. 13 shows a side view of the portion of the fuel heating device according to a first embodiment of the invention, wherein the heating device is connected to an injector and to a fuel line, according to a first installation possibility (as is shown in FIGS. 1 and 2);

FIG. 14 shows a side view of the portion of the fuel heating device of the present invention according to a first embodiment of the invention, wherein the heating device is connected to a fuel line. In this figure, the first installation possibility is used (as is shown in FIGS. 1, 2 and 13);

FIG. 15 shows a side view of the portion of the fuel heating device according to a first embodiment of the present invention, wherein the heating device is connected to a fuel line and the internal components of the heating device (with the exception of the deflector) have been removed for better distinguishability. In this figure, the first installation possibility is also used (as is shown in FIGS. 1, 2, 13 and 14);

FIG. 16 shows a sectional image of the fuel heating device according to a first embodiment of the present invention, wherein the heating device is connected to a fuel line. In this figure, the first installation possibility is also used (as is shown in FIGS. 1, 2, 13, 14 and 15);

FIG. 17 shows a top view of the heating device without the inserted components;

FIG. 18 shows a detail view and a sectional image of the fuel heating device of the present invention according to a second particular embodiment;

FIG. 19 shows a sectional image of the fuel heating device of the present invention according to a second particular embodiment; and

FIG. 20 shows an exploded illustration of the components of the heating device of the present invention according to a second particular embodiment.

### DETAILED DESCRIPTION

The invention is now described with reference to the enclosed figures. In the figures and in the following description, similar parts are identified by the same reference numbers. The figures are not necessarily true to scale, which means that particular characteristics of the invention can be illustrated in an exaggerated scale or in a diagrammatic manner. Also, the details of the conventional elements are possibly not represented so that this description is shown with greater clarity and conciseness. The terms “axial” and “radial” and “circumferential direction” refer in the present context to a longitudinal central axis of the respective heating device, wherein the axial direction runs parallel to the longitudinal central axis, the radial direction runs perpendicularly to the axial direction, and the circumferential direction runs around the longitudinal central axis.

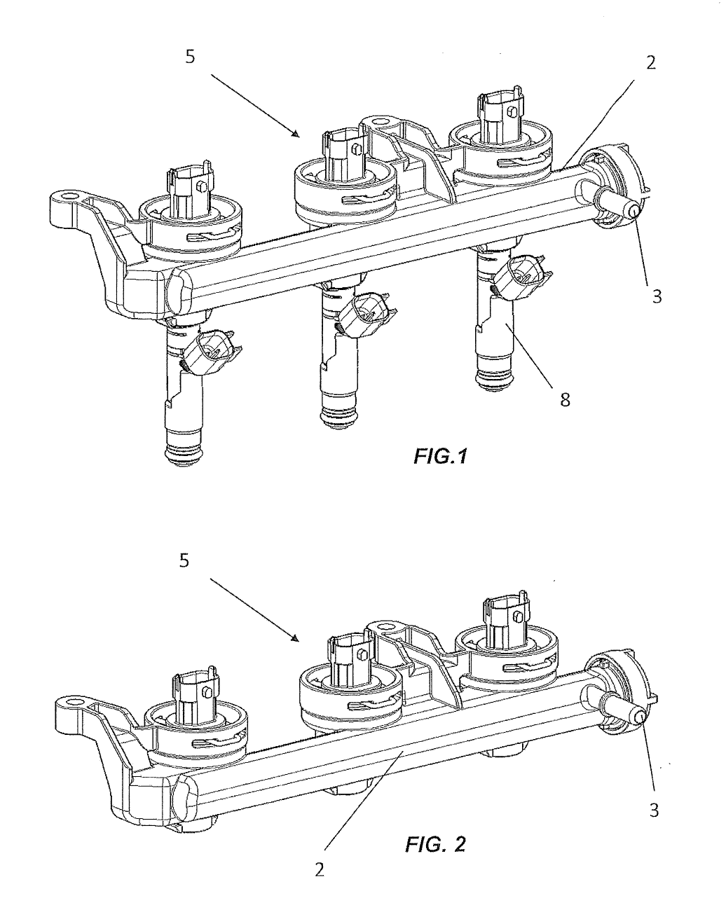

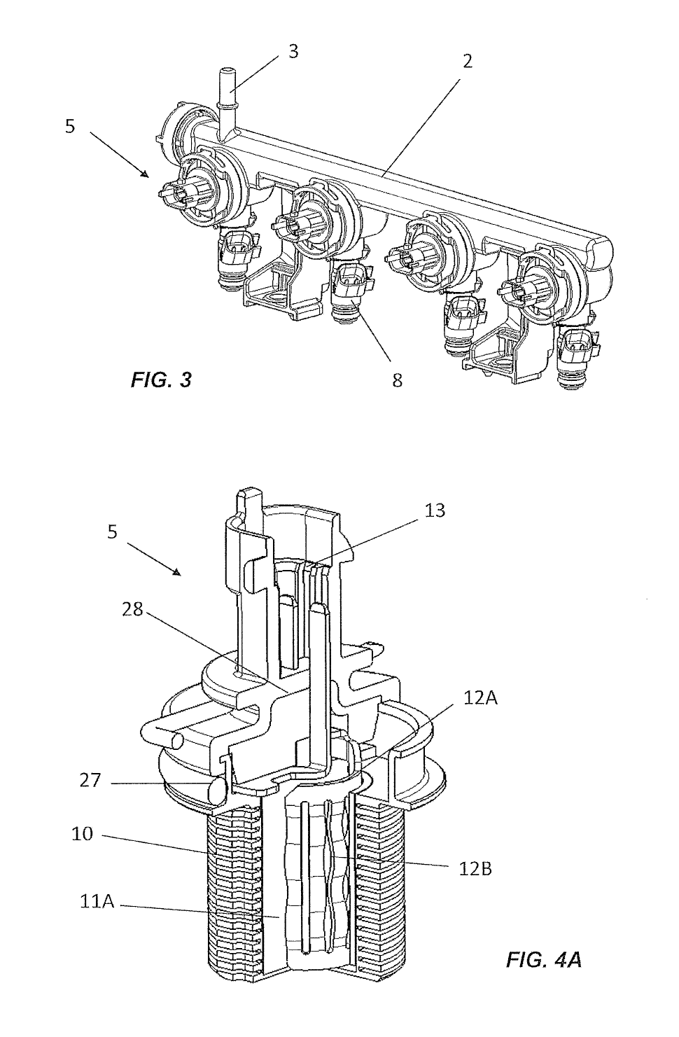

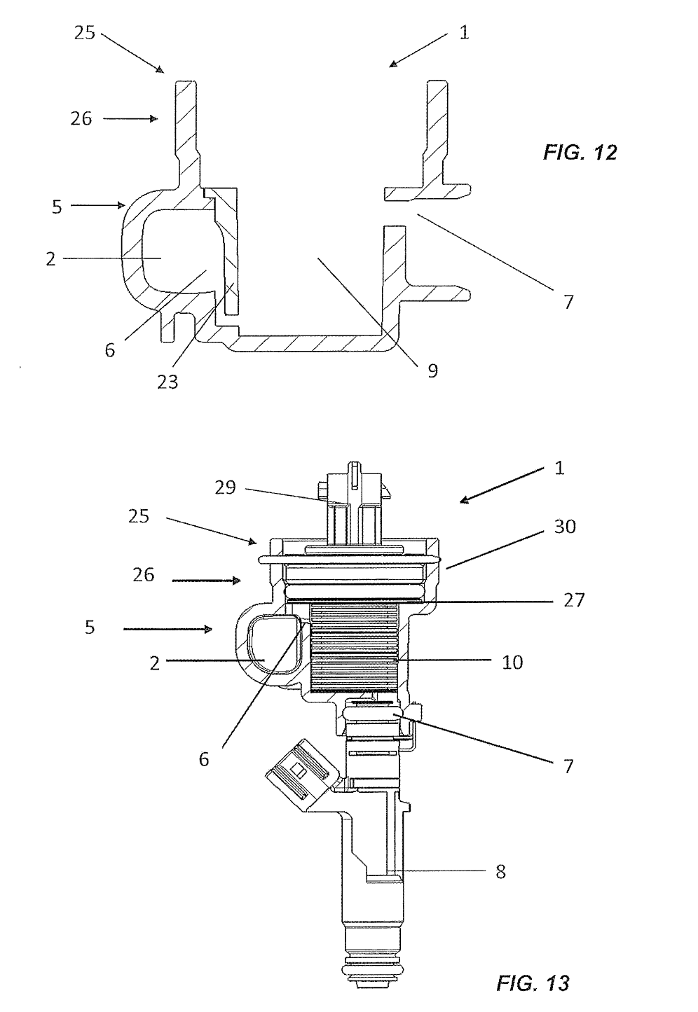

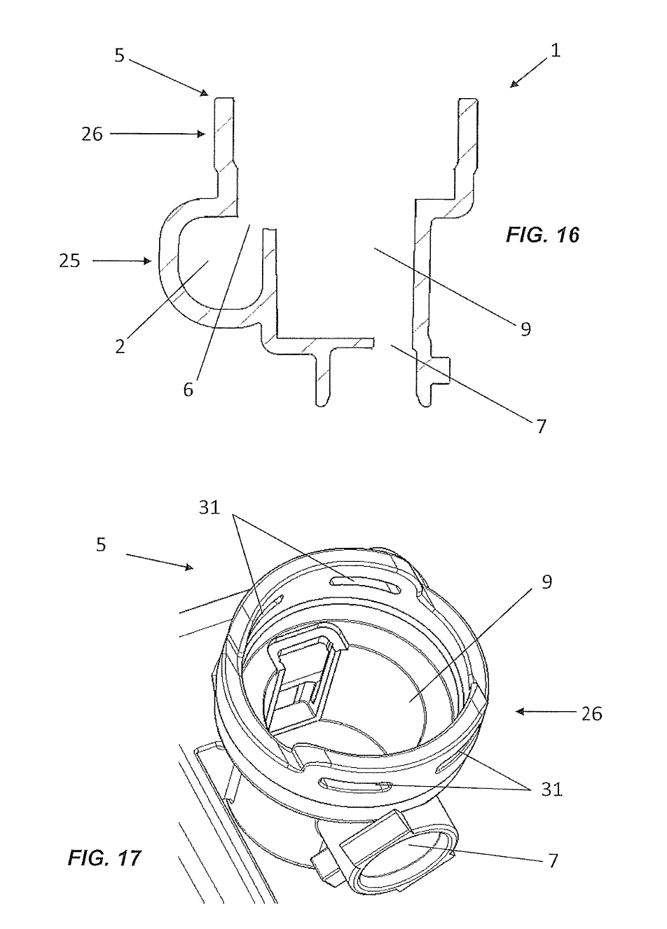

The heating device 5 of the following invention can be connected to a fuel line 2, as can be seen from FIGS. 1, 2 and 3. From FIGS. 1, 2, 3, 11, 12, 15 and 16 it can be seen that the fuel line 2 is provided with a fuel inlet 3 and with a fuel outlet, which is not designated here in further detail. Generally, the fuel line 2 has several fuel outlets for several heating devices 5. Each heating device 5 also has a fuel inlet 6 and a fuel outlet 7. It is also noteworthy that the fuel inlet 6 of the heating device 5 is fluidically connected to the fuel outlet of the fuel line 2. Consequently, the fuel outlet of the fuel line 2 can be implemented so that it conforms to the fuel inlet 6 of the heating device 5. In particular, the heating device 5 can be inserted with its fuel inlet 6 directly into the associated fuel outlet of the fuel line 2. This can be seen most clearly in FIGS. 11, 12, 15 and 16. In addition, the fuel outlet 7 of the heating device 5 can be connected to a fuel injector 8, as can be seen from FIGS. 9 and 13. In particular, the respective fuel injector 8 can be inserted here directly into the associated fuel outlet 7.

In FIGS. 11, 12, 15 and 16 a heating device 5 can be seen, which has an inner chamber 9 which is arranged between its inlet 6 and its fuel outlet 7.

This structure shows that the fuel coming out from the vehicle tank runs through the line 2, travels through the inner chamber 9 of the heating device 5 and finally is injected into the engine by means of one or more injectors 8.

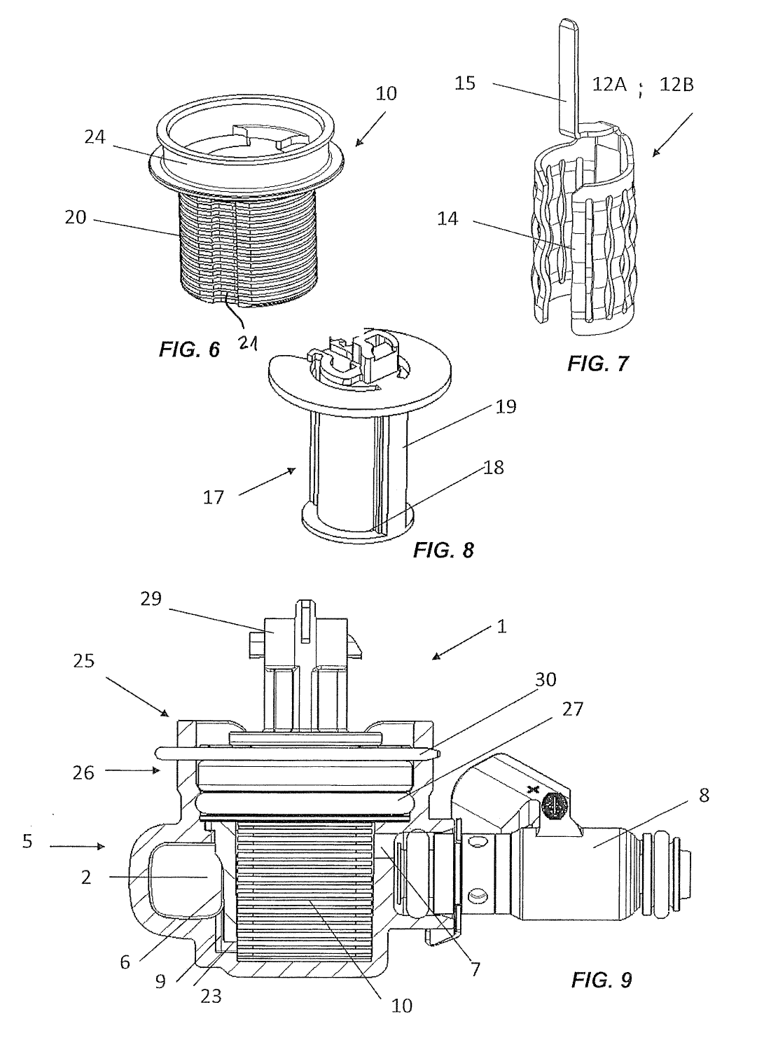

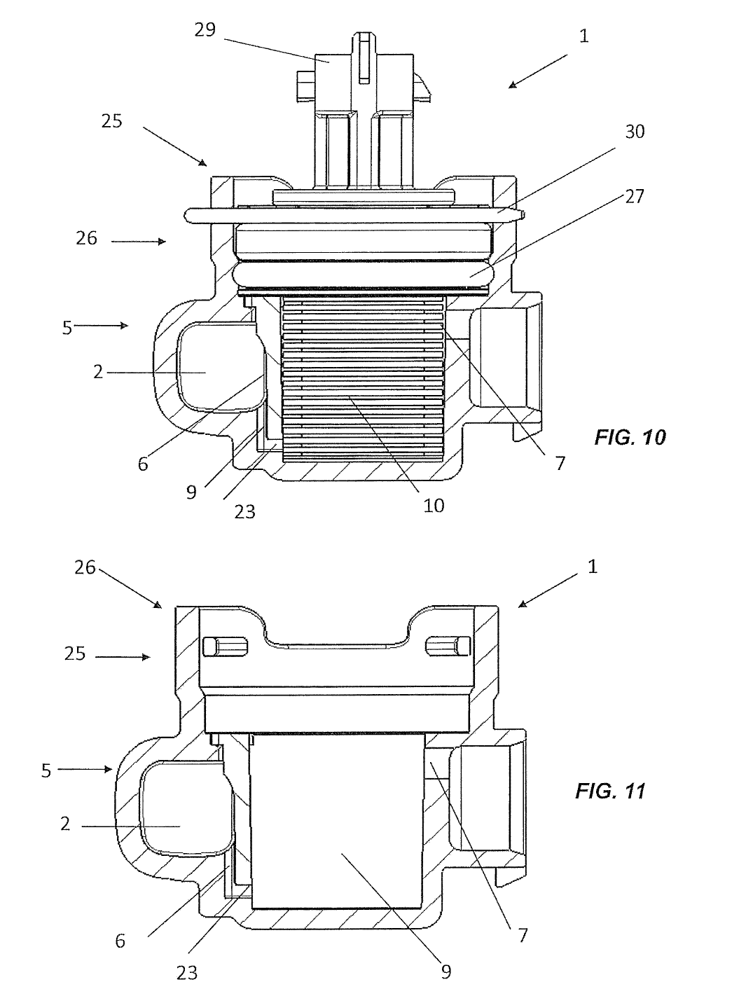

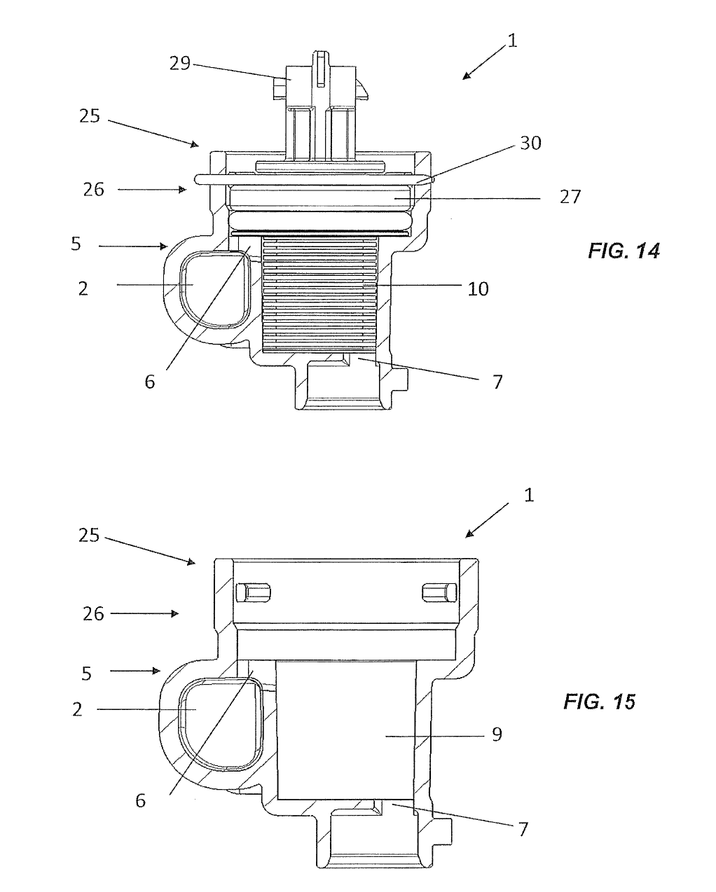

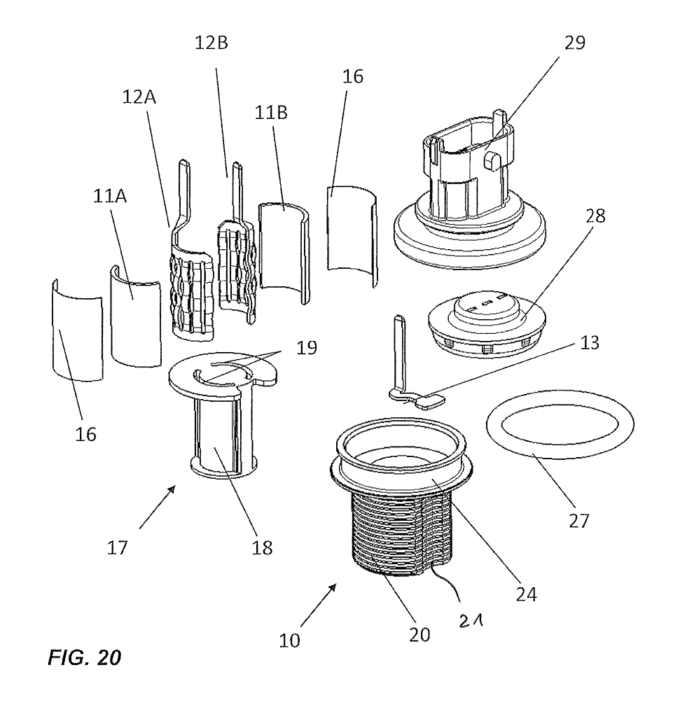

So that the fuel is heated appropriately, this invention has a heat exchanger 10, which is incorporated in the inner chamber 9 of the heating device 5. As FIGS. 6 and 20 show, the heat exchanger 10 has a ribbed portion 20 with a plurality of ribs on its outer lateral surface or outer surface, and an upper and continuous sealing portion 24 along the said ribbed portion 20. Taking into consideration these two portions 20 and 24 of the heat exchanger 10, the inner chamber 9 is adapted so that it can receive these components or respectively portions 20, 24 in its interior, wherein for this purpose it is provided with a container 25 and a fastening- and sealing connecting-piece 26. As FIGS. 9, 10, 13 and 14 show, the container 25 is configured for receiving or respectively conditioning the ribbed portion 20, while the fastening- and sealing connecting-piece 26 is configured for receiving the sealing portion 24 of the heat exchanger 10. According to a first particular embodiment of the present invention, the heat exchanger 10 has a substantially circular cross-section, as is shown in FIG. 6, wherein this has a recess 21 on the outer surface of the ribbed portion 20 on at least a part of its outer surface. Furthermore, the heat exchanger 10 is preferably made from metallic material. However, other heat- and current-conducting materials are not precluded, which are just as effective as or better than metals and which can possibly be used.

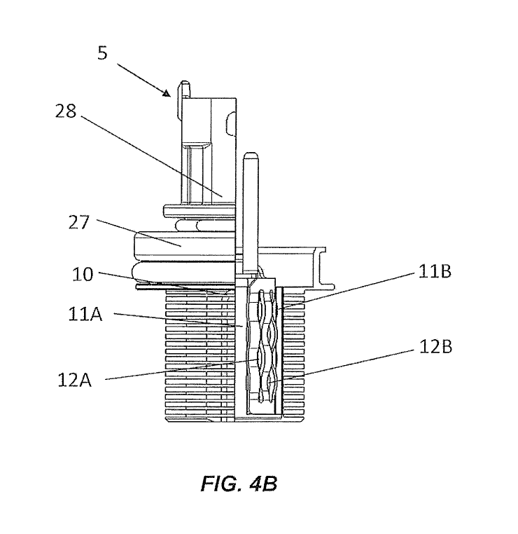

The heat exchanger 10 is also equipped with at least two heating elements 11A and 11B, which are inserted into an opening which is formed in the interior of the heat exchanger 10, as can be seen from FIGS. 4A, 4B, 18 and 19. These heating elements 11A and 11B are preferably a thermistor of the PTC type (positive temperature coefficients). In a particular embodiment of the present invention, the heating elements 11A and 11B can have the same behaviour and the same heating temperature or different behaviours and/or heating temperatures. The heating temperature here is the control temperature of the PTC element, therefore the temperature to which the PTC element heats up and starting from which the PTC element no longer receives any electric current. At least one first electrical conductor 12A exists in the same opening of the heat exchanger 10, where the heating elements 11A and 11B are situated.

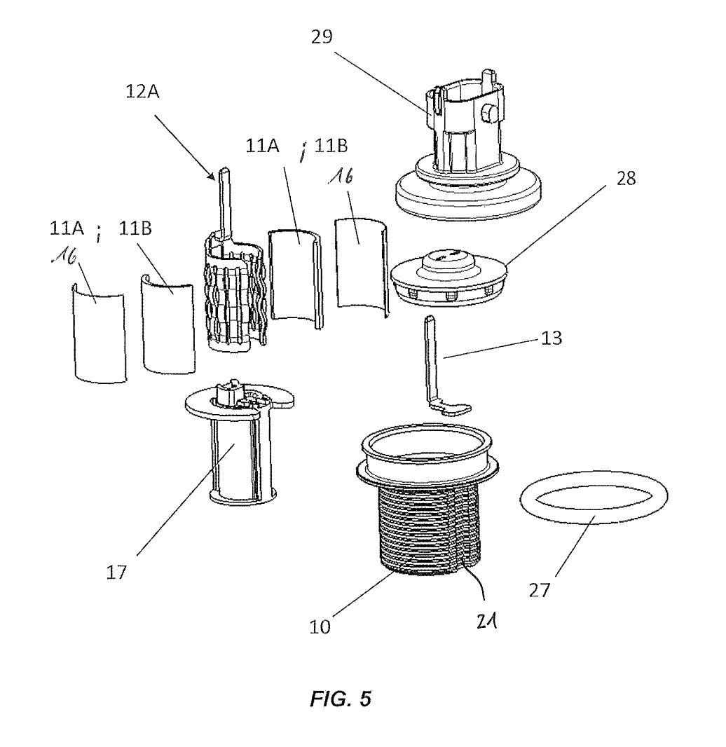

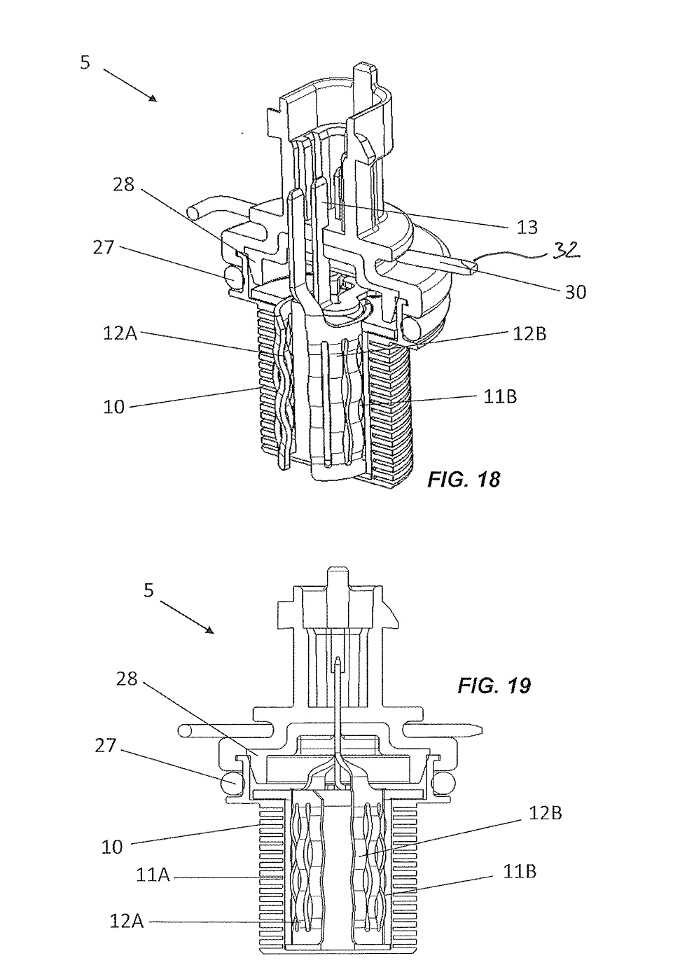

In a particular embodiment of the present invention, the heating device 5 has a first curved electrical conductor 12A, as is shown for example in FIG. 5. In a further embodiment of the present invention, the heating device 5 of this invention has in addition a third electrical conductor 12B, which likewise has a curved format, as is shown in FIGS. 18 to 20. In the following embodiments, the electrical conductor 12A and/or 12B is respectively in electrical contact with the first and the second heating element 11A and 11B. In the embodiments shown in the figures, the first electrical conductor 12A and the third electrical conductor 12B are a conductive spring, which is illustrated for example in FIGS. 5, 7 and 20. This spring consists of a contact portion 14, which chamfers the heating elements 11A and 11B, and of an electrical contact end 15, which is fully integrated into the contact portion 14. In the embodiment illustrated in FIG. 5, the contact portion 14 consists of two curved side parts (or portions) lying opposite, which stand at a distance from one another. In the embodiment illustrated in FIGS. 17 to 20, the contact portion 14 of the respective electrical conductors 12A and 12B consists of a single side part (or a single portion).

The heat exchanger 10 comprises furthermore a second electrical conductor 13, which is in electrical contact with its outer surface. This second electrical conductor 13 can be fastened to the heat exchanger 10 by any desired means, such as for example by weld seams or screws. In the embodiment illustrated in FIG. 5, the second electrical conductor 13 is screwed tightly to the heat exchanger 10 by means of a screw 22. Furthermore, the electrical conductors 12A, 13 and 12B are electrically connected to a current circuit, as shown by the embodiment illustrated in FIGS. 4A, 4B and 5, and the embodiment illustrated in FIGS. 18 to 20. In the case of the first conductor 12A and of the third conductor 12B, the contact is produced through the end 15 of each conductor. Preferably, the respective current circuit is a current circuit which is already present in the engine control of the vehicle. Furthermore, it can be seen from FIGS. 5, 7 and 20 that the contact portion 14 and the electrical contact end 15 were produced from a single part.

In the embodiment illustrated in FIGS. 18 to 20, the first heating element 11A and the second heating element 11B are situated along a side part of a contact portion 14 of the first electrical conductor 12A and of the third electrical conductor 12B. In the embodiment illustrated in FIG. 5, the first heating element 11A is situated along the one side part of the contact portion 14 of the first electrical conductor 12A and the second heating element 11B is situated along the other side part of the contact portion 14 of the first electrical conductor 12A. In both embodiments respectively thereby, viewed radially, a “sandwich” structure is formed.

In an embodiment of the present illustrated invention, it can be determined that the heating elements 11A and 11B have a substantially curved shape, as can be seen for example from FIG. 5. This curvature can be, in particular, in the shape of a circular arc.

In order to hold the “sandwich” structure together, to insert it correctly and to incorporate it easily, in addition a holder 17 is provided, as is shown in FIGS. 5, 8 and 20. In more precise terms, the two heating elements 11A and 11B are held together by means of the said holder 17, which, furthermore, is made from polymer material. The holder 17 has, in addition, front and rear support regions 18, in order to fasten or respectively position the heating elements 11A and 11B so that they can be removed easily. Moreover, the holder 17 has mounts 19 arranged concentrically to the longitudinal central axis, in order to receive and position the first electrical conductor 12A and the third electrical conductor 12B (in the case of the embodiment illustrated in FIGS. 18 to 20). The holder 17 can have various forms. In FIGS. 5 and 8, the holder 17 has, for example, flat support regions 18 and concentric mounts 19 on a surface which can be shaped just as the heat exchanger 10, e.g. can have an elongated or elliptical shape, when this corresponds to the cross-section of the heat exchanger 10. In a further embodiment of the invention illustrated in FIG. 20, the holder 17 has a circular cross-section and the concentric mounts 19 have the shape of a circular arc.

In a particular embodiment of the present invention and with the aim of improving the heat conduction of the heating elements 11A and 11B, which flows out through the heat exchanger 10, alternatively one or more heat-conducting foils 16 can be provided. In the particular embodiments of the present invention illustrated in FIGS. 5 and 20, the heat-conducting foils 16 are placed around the “sandwich” structure, which is formed from the heating elements 11A and 11B, the contact portions 14 of the first electrical conductor 12A (just as from the third conductor 12B in the case of the embodiment of FIGS. 18 to 20) and the holder 17. In FIG. 5, the foil 16 has such a shape which enables it to envelop the holder 17 with the first conductor 12A and the incorporated elements 11A and 11B. In FIG. 5 the foil 16 likewise envelops the holder 17 with the first and third electrical conductor 12A and 12B and with the incorporated elements 11A and 11B. In FIGS. 5 and 20 it can be determined that the heat-conducting foils 16 have a curved shape, so that they can envelop the elements which form the likewise curved “sandwich” structure.

With regard to the sealing of the heating device 5 of the present invention, firstly it is noteworthy that the sealing portion 24 of the heat exchanger 10 is configured so that it can receive at least one sealing element 27. In the embodiment illustrated in the figures, the respective sealing element 27 is a sealing ring of the “O-ring” type, which is incorporated into the sealing portion 27 of the heat exchanger 10 and which is illustrated in FIGS. 4A, 4B, 5, 9, 10, 13, 14, 18, 19 and 20. In addition, reference is now made to FIGS. 5 and 20; a protective cover 28, which in an optional embodiment of the present invention securely holds the electrical conductors 12A, 12B and 13, lies over the sealing portion 24 of the heat exchanger 10. In more precise terms, the protective cover 28 is fastened over all electrical conductors 12A, 12B and 13, wherein the fastening can take place for example by means of bores on the protective cover 28. In addition, a plastic cover 29 lies over the protective cover 28, wherein this cover 29 can be injected onto the protective cover 28. The final form of this injecting around, or respectively injecting on, can be seen for example in the embodiments illustrated in FIGS. 4A, 4B, 9, 13, 18 and 19.

The fastening of the components in the interior of the inner chamber 9 is now shown in FIGS. 5, 9 to 17 and 20. As can be determined, the heating device 5 is provided with a bracket-shaped fastening clamp 30 for each heating device 5. This clamp 30 is inserted in through-openings 31, which are formed on the fastening- and sealing connecting-piece 26. On introducing into the openings 31, the clamp 30 places itself around the plastic cover portion 29 which is situated in the interior of the fastening- and sealing connecting-piece 26. The said clamp 30 has, in addition, free ends 32, which enable a secure fastening. For this, the ends 32 can be bent outwards, therefore directed away from one another, so that they can cooperate with an opening edge of the respective opening 31.

Apart from the components already mentioned, the heating device 5, in a particular embodiment of the present invention, can optionally have a deflector 23, as can be seen from FIGS. 9 to 12. This deflector 23 is arranged at the fuel inlet 6 (in the region illustrated in FIG. 17) and serves for deflecting the incoming fuel flow into the lower region of the inner chamber 9 of the heating device 5. In particular, the deflector 23 brings about as uniform a distribution as possible of the incoming fuel to the entire axial height of the ribbed portion 20. Through this deflector 23, a greater contact time of the fuel with the heat exchanger 10 is enforced, before it is injected. The deflector 23 expediently engages into the above-mentioned recess 21, which is formed on the outer side of the heat exchanger 10.

In a particular embodiment of the present invention, the heating device 5 and the line 2 are fully incorporated. In other words, these two components can form a single part. In a particular embodiment of the present invention, the heating device 5 and the line 2 are produced by means of moulding and injecting of polymer materials. After construction, the heat exchanger 10 (and all further components which are situated in its interior), the deflector 23 (optionally), the sealing element 27 and the protective cover 28, onto which subsequently the plastic cover 29 is injected, are mounted in the interior of the inner chamber 9.

With regard to the installation possibility, it can be determined by means of FIGS. 1 to 3 and 9 to 16 that there are some variants. In a particular embodiment of the present invention, the fuel inlet 6 and the fuel outlet 7 of the heating device 5 can be arranged so that they form an angle (in relation to one another), which varies for example between 0° and 90°. Therefore, for example, FIGS. 9 to 12 show that this angle is substantially 0° in size, so that the fuel inlet 6 and the fuel outlet 7 lie diametrically opposite. In contrast thereto, in FIGS. 13 to 16 this angle is less than 90°, and in FIG. 4 the angle is substantially 90° in size. Of course, the angle between the fuel inlet 6 and the fuel outlet 7 of the heating device 5 can vary depending on the engine configuration, the space available and the application, etc., so that the figures merely present an example for the various possible arrangements.

As can be determined, the heating device 5 of the present invention is fully integrated, whereby it is therefore a single part for which no “clips” and sealing rings are necessary in order to fasten the heating devices 5 and the fuel line 2. In connection with this characteristic, in addition the strong sealing and the fixing of the parts are to be emphasized, which, owing to the injecting-on of the plastic cover 29 and the function of the protective cover 28, fasten all components. This also includes the clamp 30, which cooperates in the fixing.

Furthermore, in the embodiment illustrated in FIGS. 18 to 20 it can be seen that the fact that the heating device 5 has at least three electrical conductors 12A, 12B and 13, creates a range of advantages. Among these advantages, the following is to be mentioned: two heating elements 11A and 11B can be activated in a single operation, whereby the heat emitted to the fuel is increased, or a selection can be made as to whether only one heating element is used. When the vehicle requires a rapid heating of the fuel, therefore the first and the second heating element 11A and 11B can be activated. When the vehicle requires a merely slightly heated fuel, only one of the heating elements 11A or 11B is activated.

The control possibilities concerning the heat which is supplied to the fuel are increased with the possibility that the heating elements 11A and 11B can have different behaviours and heating temperatures. The possibility of being able to activate one or the other heating element or even both simultaneously thereby offers flexibility to the cold starting system of the vehicle, whereby the possibility of providing the consumer with a better product is increased.

With these electrical conductors 12A, 12B and 13, the engine control of the vehicle can be set in order to supply the heating elements 11A, 11B in chronologically different intervals. For example, a short period of time can be set for the pre-heating of the fuel, so that both heating elements 11A and 11B are activated simultaneously in the first few seconds before the starting of the vehicle. Thereby, the driver does not have to wait long in order to be able to drive his car, because the fuel already has the ideal temperature when the starting system is activated.

A further advantage and a control possibility of the present invention relates to the fact that the engine control can be set with control strategies of the “On-Off” type, or even uses a pulse width modulation (PWM).

By means of these characteristics, it can be determined that the fuel heating device 5 provides a versatile solution which offers numerous possibilities for controlling the heat which is supplied to the fuel. Owing to the fact that the invention offers various control types and control strategies, the present invention can provide means so that the fuel always has the ideal temperature for the cold start and for using the vehicle.

The fact that the cross-section of the heat exchanger 10 has a round shape, preferably a substantially circular shape, increases the contact surface between the heating elements 11A and 11B and the internal portion of the heat exchanger 10. Furthermore, a part having a round cross-section is easier to produce and also facilitates the execution of the grooves or respectively ribs. The ease of obtaining this part reduces the process errors and optimizes the manufacturing costs. Moreover, the heating elements 11A and 11B can be arranged in positions with greater distance from one another with respect to the heat exchanger 10 with an elongated shape. Therefore, the heat generated by the heating elements 11A and 11B is directed almost entirely to the heat exchanger 10.

Therefore, the circular cross-section results in a considerable increase in the heating output and a drastic reduction of the manufacturing costs, wherein with such a success the problems of the prior art are solved.

As is known to the specialists, numerous changes and variations of the invention are therefore possible in view of the above-mentioned findings, without, in so doing, departing from the scope of protection which is defined by the accompanying claims.

1. A fuel heating device (5), which is characterized in that it contains the following:
a fuel inlet (6) and at least one fuel outlet (7);
wherein the heating device (5) has at least one inner chamber (9), which is arranged between the fuel inlet (6) and the fuel outlet (7);
in the said inner chamber (9) at least one heat exchanger (10) is arranged, wherein the heat exchanger (10) has at least one first and one second heating element (11A, 11B), which are inserted into an opening into an interior of the heat exchanger (10);
the heat exchanger (10) comprises in addition at least:
one first electrical conductor (12A) in its interior, which is in electrical contact with the first heating element (11A); and
one second electrical conductor (13), which is in electrical contact with the outer surface of the heat exchanger (10),
wherein the heat exchanger (10) has in addition a round, in particular circular, cross-section.

2. The heating device according to claim 1, which is characterized in that the first electrical conductor (12A) is a conductive spring, which comprises the following:
a contact portion (14), which serves to produce contact with the heating elements (11A), 11B); and
an electrical contact end (15), which produces the contact to an electrical current circuit of a motor vehicle.

3. The heating device according to claim 1, which is characterized in that the contact portion (14) of the first electrical conductor (12A) has a curved shape.

4. The heating device according to claim 3, which is characterized in that the contact portion (14) has two curved, opposite, side parts, which stand at a distance from one another.

5. The heating device according to one of claims 1 to 4, which is characterized in that the first heating element (11A) extends along the one side part of the contact portion (14) of the first electrical conductor (12A), and the second heating element (11B) extends along the other side part of the contact portion (14) of the first electrical conductor (12A).

6. The heating device according to claim 4 or 5, which is characterized in that the first and the second heating element (11A, 11B) are fastened to the respective side part of the contact portion (14) of the first electrical conductor (12A) by means of a holder (17), wherein the said holder (17) has a front and rear support wall (18), in order to position the heating elements (11A, 11B), and mounts (19), in order to position each side part of the contact portion (14) of the first electrical conductor (12A).

7. The heating device according to claim 6, which is characterized in that the contact portion (14) of the first electrical conductor (12A), the heating elements (11A, 11B) and the holder (17) form a “sandwich” structure.

8. The heating device according to claim 7, which is characterized in that it has, in addition, at least one heat-conducting foil (16) around the “sandwich” structure.

9. The heating device according to one of claims 1 to 8, which is characterized in that the heating elements (11A 11B) are thermistors.

10. The heating device according to one of claims 1 to 9, which is characterized in that the heat exchanger (10) comprises the following:
a ribbed portion (20) with a plurality of ribs on its outer surface for contacting with the fuel.

11. The heating device according to claim 10, which is characterized in that the heat exchanger (10) comprises the following:
at least one recess (21) on the outer surface of the ribbed portion (20).

12. The heating device according to claim 11, which is characterized in that the at least one recess (21) is situated on at least a portion of the outer surface of the heat exchanger (10).

13. The heating device according to claim 6 or according to claim 6 and one of claims 7 to 12, which is characterized in that the holder (17) has a cylindrical shape, wherein its mounts (19) are arranged in the shape of a circular arc and concentrically.

14. The heating device according to claim 8 or according to claim 8 and one of claims 9 to 13, which is characterized in that the first and second heating element (11A, 11B) and at least one heat-conducting foil (16) have a curved shape.

15. The heating device according to one of claims 1 to 14, which is characterized in that it has at least one deflector (23) embedded into the fuel inlet (6), the function of which deflector is to divert the incoming flow of fuel into the lower region of the inner chamber (9) of the heating device (5).

16. The heating device according to claim 11 or 12 and 15, characterized in that the deflector (23) engages into the recess (21).

17. The heating device according to claim 10 or according to claim 10 and one of claims 11 to 16, which is characterized in that the heat exchanger (10) has an upper and continuous sealing portion (24) along the ribbed portion (20), wherein the function of the said sealing portion (24) is to receive at least one sealing element (27).

18. The heating device according to claim 17, which is characterized in that the inner chamber (9) has a container (25) and a fastening- and sealing connecting-piece (26), wherein the container (25) is configured for receiving the ribbed portion (20) of the heat exchanger (10), while the fastening- and sealing connecting-piece (26) is configured for receiving the sealing portion (24) of the heat exchanger.

19. The heating device according to claim 18, which is characterized in that the sealing element (27) is a sealing ring of the “O-ring” type.

20. The heating device according to claim 18 or 19, which is characterized in that a protective cover (28) lies over the sealing portion (24) of the heat exchanger (10), which protective cover securely holds the first (12A), the second (13) and the third (12B) electrical conductor.

21. The heating device according to claim 20, which is characterized in that a plastic cover (29) lies over the protective cover (28) which plastic cover can, in particular, be sprayed onto the protective cover (28).

22. The heating device according to one of claims 18 to 21, which is characterized in that it has, in addition, a fastening clamp (30), which is inserted in through-bores (31) of the fastening- and sealing connecting-piece (26) and is arranged encompassing the plastic cover portion (29), which is situated in the interior of the fastening- and sealing connecting-piece (26).

23. The heating device according to one of claims 1 to 22, which is characterized in that the fuel inlet (6) of the heating device (5) can be directly connected fluidically to the fuel outlet of a fuel line (2), in particular inserted, and that the fuel outlet (7) of the heating device (5) can be directly connected to at least one fuel injector (8), in particular inserted.

24. The heating device according to claim 23, which is characterized in that it is fully incorporated into the fuel line (2).

25. The heating device according to claim 7 or according to claim 7 and one of claims 8 to 24, which is characterized in that the first heating element (11A) and the second heating element (11B) have the same behaviour and/or the same limit regulation temperature.

26. The heating device according to claim 9 or according to claim 9 and one of claims 10 to 24, which is characterized in that the first heating element (11A) and the second heating element (11B) have different behaviours and/or limit regulation temperatures.

27. The heating device according to one of claims 1 to 26, which is characterized in that in the opening of the heat exchanger (10) a third electrical conductor (12B) is present, wherein the said third electrical conductor (12B) is in electrical contact with the second heating element (11B) and has a curved format.

28. The heating device according to claim 27, which is characterized in that the third electrical conductor (12B) is a conductive spring, which comprises the following: a curved contact portion (14), which produces the contact to the heating elements (11A, 11B); and an electrical contact end (15), which produces the contact to an electrical current circuit of a motor vehicle.

29. The heating device according to claims 1 and 2, which is characterized in that the first heating element (11A) extends along the one side part of the contact portion (14) of the first electrical conductor (12A), and the second heating element (11B) extends along the other side part of the contact portion (14) of the third electrical conductor (12B).

30. The heating device according to claim 29, which is characterized in that the first and the second heating element (11A), 11B) are fastened to the respective side part of the contact portion (14) of the first and of the third electrical conductor (12A, 12B) by means of a holder (17), wherein the said holder (17) has a front and rear support wall (18), in order to position the heating elements (11A, 11B), and mounts (19), in order to position the first and third electrical conductor (12A, 12B).

31. The heating device according to claims 29 and 30, which is characterized in that the contact portions (14) of the first and of the third electrical conductor (12A, 12B), the heating elements (11A, 11B) and the holder (17) form a “sandwich” structure.

32. A fuel injection device for an internal combustion engine, which has at least one cylinder,
with at least one fuel injector (8) for the injecting of fuel into the cylinder,
with at least one fuel line (2) for supplying the fuel to the respective fuel injector (8),
with at least one heating device (5) for the demand-dependent heating of the fuel, which is arranged fluidically between the fuel line (2) and the respective fuel injector (8).

33. The fuel injection device according to claim 32, characterized in that
the heating device is configured according to claim 26,
a control device is provided, which is configured so that depending on at least one control parameter, such as e.g. fuel temperature in the fuel line or environmental temperature or fuel type or fuel composition, it optionally activates only the first heating element (11A) or only the second heating element (11B) or both heating elements (11A, 11B) for heating the fuel.
